(19) United States
(12) Patent Application Publication
(10) Pub. No.: US 2006/0020616 A1
(43) Pub. Date: Jan. 26, 2006

(54) Indexing operational logs in a distributed processing system

(76) Inventors: Geoffrey Hardy, Boston, MA (US); Marco Lara, Topsfield, MA (US); Stanley Yamane, Needham, MA (US); Jason Debettencourt, Medfield, MA (US)

Correspondence Address: FISH & RICHARDSON PC, P.O. BOX 1022, MINNEAPOLIS, MN, 55440-1022, US

(21) Appl. No.: 10/897,375

(22) Filed: Jul. 22, 2004

(51) Int. Cl. G06F 17/30

(52) U.S. Cl. 707/101

(57) ABSTRACT

Records written to each of a number of logs, such as logs in a distributed processing system, are monitored. An index to records in the logs is generated according to the monitoring of the records. The writing of records to each of the logs is performed by a corresponding task, and the monitoring and generating are performed by one or more tasks that are separate from the tasks performing the writing of the records. When log records are removed, updating of the index can be deferred or performed according to a schedule such that the index does not reflect the removal of the log records.

### BACKGROUND

This invention relates to indexing of operational logs in a distributed processing system.

Distributed processing systems are used in a variety of applications, including for processing transactions in which multiple services may be needed to process each transaction, and the services may be hosted on different server computers. One architecture currently used for such distributed systems is referred to as a “Web services architecture.” In a Web services architecture, a set of services is typically distributed over multiple server computers. Each service typically performs a specific task or set of tasks. A service can make use of other services in a hierarchical or nested fashion. For example, a purchasing service may make use of nested inventory, shipping, and billing services. These nested services may be hosted on the same or on different computers.

A standard approach to communicating with and between Web services makes use of the eXtensible Markup Language (XML). Data encoded using XML includes text-based messages with explicit tagging of data fields. A message can include nested data fields. For example, an “item” in a purchase order message can include nested “quantity” and “part number” fields. Syntax specification for input and output XML data for Web services can make use of the Web Services Description Language (WSDL).

Each of the distributed services may log data related to the transactions handled by those services. For example, each service may write records to a log file as it processes transactions, and it may create a new log file each day. These logs may be useful for monitoring the behavior of one of more of the services either in an off-line mode in which the logs from various services are collected and processed together, for example, at the end of a day of processing, or may be used in an on-line monitoring mode in which a monitoring application may access portions of the logs for applications such as an alerting application.

### SUMMARY

In one aspect, in general, the invention features a method, and an associated system and software, in which records written to each of a number of logs are monitored. An index to records in the logs is generated according to the monitoring of the records.

Aspects of the invention can include one or more of the following features:

The records are written to each of the plurality of logs.

The writing of records to each of the logs is performed by a corresponding task, and the monitoring and generating are performed by one or more tasks that are separate from the tasks performing the writing of the records.

The writing of records to each of the logs is performed by a corresponding separate task for each of the logs. Each of at least some of the corresponding separate tasks can be associated with different instances of a single service.

The tasks performing the writing and the task or tasks performing the monitoring and generating can include a process, a thread, or a program execution.

The writing, the monitoring, and the generating are hosted on a single computer.

The method can further include monitoring messages, and generating log records representing the monitored messages. The writing of the records to the logs then includes writing the log records to the logs.

The writing of the records to the logs includes writing records to disk copies of the logs. The monitoring of the records includes monitoring the records written to the disk copies.

In another aspect, in general, the invention features a method, and an associated system and software, for indexing log files in a distributed processing system. The method includes, for each of a plurality of service instances, in a task associated with that service instance, monitoring messages communicated with the service instance and writing log records associated with the monitored messages to a log file associated with that service instance. In one or more tasks that are separate from the tasks associated with the service instances, the log records written to the logs are generated and an index to records in the logs is generated according to the content of the monitored records.

Aspects of the invention can include one or more of the following features:

Each task associated with one of the service instances is a process thread that serially processes messages for the corresponding service instance.

The method further includes removing log records written to the log file, and deferring updating of the index such that the index does not reflect the removal of the log records. Removing the log records can include removing the entire log file. Deferring updating of the index can include performing the updating according to a schedule.

The index includes data stored on a non-volatile storage and buffers stored on a volatile storage. Generating the index includes updating the buffers of the index. Generating the index includes enabling recreating the index upon a failure during updating of the non-volatile storage of the index without requiring regenerating the entire index from the log file.

Aspects of the invention can include one or more of the following advantages.

It is common for operational log or tables to grow to very substantial sizes such that it may be impractical or computationally undesirable to scan the entire log each time some information is required from it. One approach is to limit the search of the log by time window. Operation logs typically consist of records that include a time-stamp, and are ordered chronologically by that time-stamp. In cases where the user can provide a limited time window within which to search the log, this time-stamp field acts as a natural index into the log. Unfortunately, this is not always the case. In cases where there exists another field in the log that can be used to exclude a significant portion of the log, it can be advantageous to maintain an index of that field that can be used to avoid scanning the entire log.

Indexes are used in databases, with particular usage models favoring a different index algorithms (i.e., B Tree, B+Tree, hashes, etc.). By taking advantage of the properties of operational logs, such as the limited situations in which records are deleted and the lack of record modifications (i.e., updates), and the properties of access to the data, such as an acceptability of not indexing the most recently added records in a log, improved performance and/or reduced complexity can be achieved as compared to direct application of database indexing methods. Unlike most database indexing applications, in indexing of operational logs it is not generally necessary to guarantee consistency between different logs, and between a log and its indices for at least some period of time. Increased efficiency can be achieved by taking advantage of such acceptable inconsistencies.

Not requiring transactional integrity enables use of separate the log and index maintenance procedures. One benefit of this approach is that a batch model can be used for index maintenance where an index is updated periodically. Such a batch approach can improve performance by enabling better and/or simpler use of buffering.

In many cases, index corruption in systems occurs because the process maintaining the index is terminated while the index is in an inconsistent state. A mechanism for identifying this case is by generating a persistent entry (file, directory or entry on a table) that is created before the update begins, and deleted when the operation is done. On startup, the index maintenance component verifies that this entry does not exist. This solution is often impractical if the frequency with which an index is updated is high. By using batch updates, which significantly reduces this frequency, this persistent file mechanism can be come practical.

Index maintenance, for example, to recover storage associated with deleted log files, can be scheduled when the system is less likely to be under heavy load. The update procedure can consists of a sequential scan of the index. Any record addressed to a log file that no longer exists is cleared. This operation can occur while the index is in use, but does not need to occur very often, because it can be very efficient for the system to detect stale entries.

Maintaining an index for log files using a separate process from those processing messages and writing to the log files can reduce the delay in processing messages.

Generating a common index for multiple instances of a common log file can allow writing to the multiple instances without requiring locking mechanisms while still providing a common index for accessing the records. In this way, from the point of view of access, the common log file functions much like a single physical file, and from the view of the writers to the log file, the writers to their own instances of the log file do not have to protect for conflicting access by other writers.

Writing updated blocks of the index file in a fail-safe manner provides an advantage that in the case of a failure during the updating of the on-disk copy of the log file based on the in-memory updated index, a consistent version of the index can be recreated on the failure without having to completely re-index all the log files.

A problem in monitoring distributed applications is having a comprehensive view of all components simultaneously and how the components interact. Typically, logs will be created, maintained and examined for separate components separately. The resulting “stovepipe” view of a distributed application can miss the complex interactions between components. This is exacerbated by the nature of some workflows where related operations are disconnected temporally so time cannot be used as the natural index. Providing indices to multiple logs can provide an efficient way of accessing a comprehensive view of the applications.

Other features and advantages of the invention are apparent from the following description, and from the claims.

### DESCRIPTION OF DRAWINGS

FIG. 1 is a block diagram of a distributed computer system.

FIG. 2 is a block diagram of a system of distributed services.

FIG. 3 is a block diagram of an application server.

FIG. 4 is a diagram that illustrates logging data.

### DESCRIPTION

Referring to FIG. 1, a distributed computer system 100 includes a number of computers that are connected together over data networks, such as over a local network 180. The computers include one or more application servers 110, each of which hosts one or more services. Additional computers are optionally linked to the application servers, including a client application server 140, and administrative computer 150, and a web server 120, which provides services to web client computers 130. The arrangement of computers shown in FIG. 1 is meant to be illustrative. Additional or fewer computers may be used, and different arrangements of data networks or other communication services can be used. For example, the application server computers may be geographically distributed and linked through a wide area network, such as the public Internet.

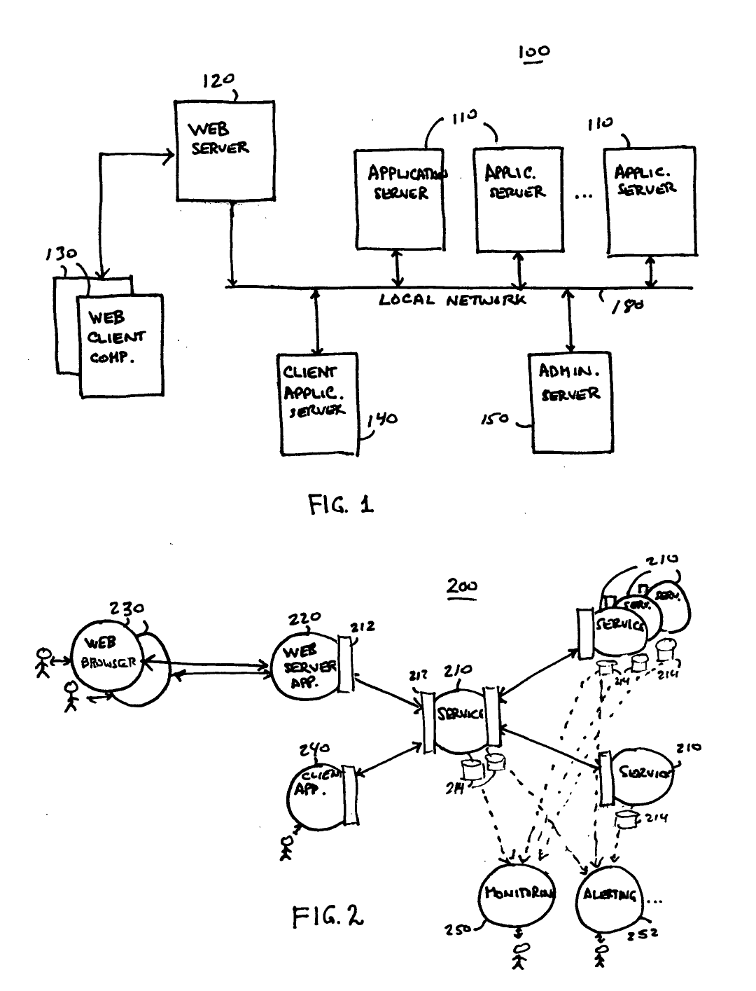

Referring to FIG. 2, the computer system 100 hosts a system 200 of interconnected clients and services. In this version of the system, the services form a Web services processing architecture. This system includes a number of services 210, each of which is hosted on one of the application servers 110 shown in FIG. 1. A client application 240 and a web server application 220 make use of particular ones of the services 210. These services in turn make use of other services 210 in a hierarchical arrangement over communication links illustrated in the figure. The web server application 220 interacts with web browsers 230. For example, the web server application 220 may convert web-based requests from a user at a web browser 230 to an XML-based web service request that it passes to one of the services 210. Note that in general, application servers can host multiple different services. In addition, multiple instances of a single service may be distributed over multiple different application servers, for example, to increase the capacity of the overall system.

In FIG. 2, services 220 are illustrated with interfaces 212 that provide connectivity with other services. In general, a service 220 does not have to deal specific communication services that are used to pass messages between the various services. For example, an interface 212 receives XML-based messages, parses the text data representation in the messages, and provides a tree-structured data representation of the data to the service.

The interfaces 212 (and/or optionally the services 210 themselves) generate logging data that is stored in log files 214. For example, records in the log files represent particular fields of messages passed to or from the services. A number of administrative applications, such as a monitoring application 250 and an alerting application 252, are hosted on the administrative server 150. These administrative applications make use of the log files 214 to track and analyze the behavior of the services.

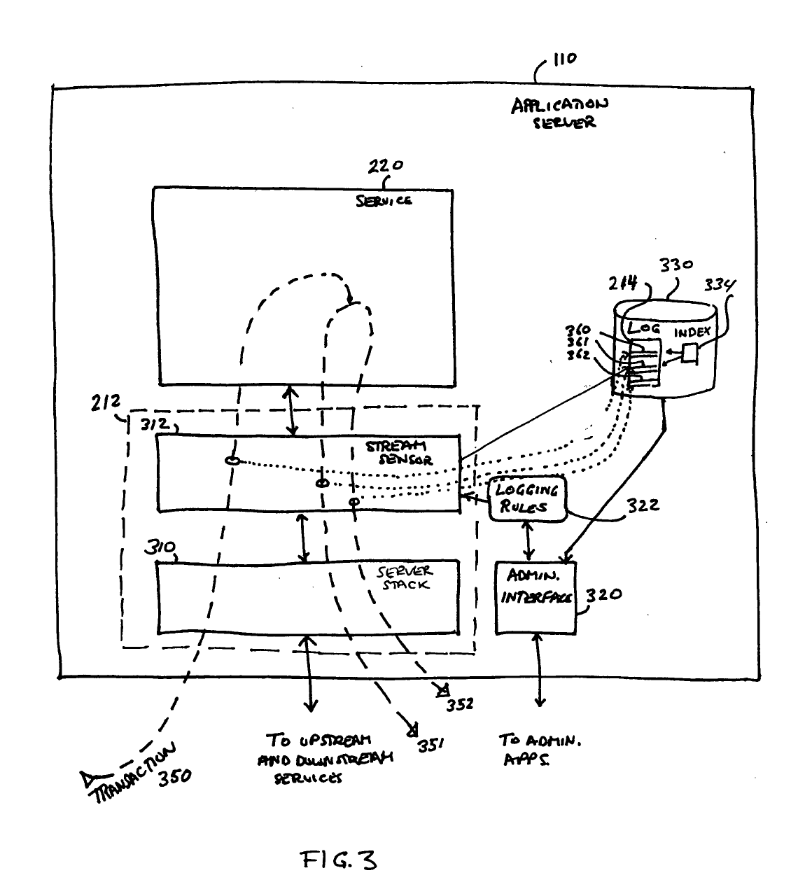

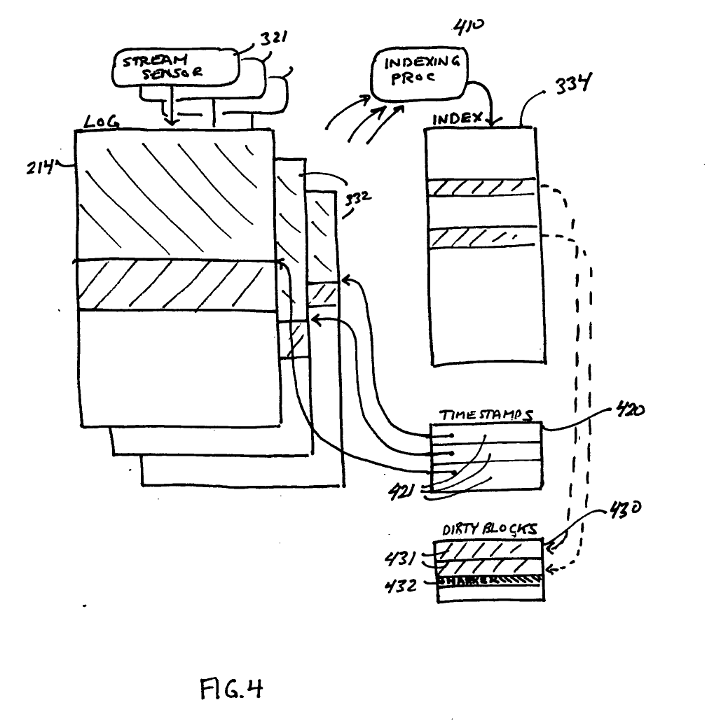

Referring to FIG. 3, a representative service 220 and interface 212 are hosted on an application server 110. The interface 212 includes a server stack 310 as well as a stream sensor 312. The server stack 310 accepts inbound service requests and processes them for further processing by the service 220. In processing the inbound service request, the service 220 may generate further requests that is sends to others services, which in general are hosted on different application servers 110. The stream sensor 312 monitors the inbound and outbound service requests without introducing substantial delays. One function of the stream sensor 312 is to log the occurrence of particular service requests or responses according to a set of logging rules 322. The logging rules are set through an administration interface 320, typically by an application on an administrative server 150 (see FIG. 1), for example, to configure a monitoring application 250 (see FIG. 2).

The logging data generated by the stream sensor 312 is stored in a log file 214 stored on a non-volatile logging device 330, such as a magnetic disk drive, along with an in-memory copy of some or all of the log file 214. For example, each service 220 may maintain one or more logs at the specification of the logging rules. For example, one log may relate to normal transactions while another log may relate to exceptional transactions (e.g., errors). The logging rules may also specify the frequency of starting new log files. For example, a service may be directed to start a new log file once every day, or once every hour. In this way, individual log files do not grow too large, and are not as subject to corruption once they are no longer being written to. Each log file 214 generally has a memory buffer (not shown) associated with it that is maintained by the operating system. For example, when an application commands the operating system to write a record to the log file, that record is typically stored in a memory buffer and not immediately written to the physical disk media. The memory buffer is repeatedly written to the physical disk media (“flushed”), for example, when the buffered data reached a threshold size, or under the explicit control of the application, which can instruct the operating system to synchronize (“sync”) its memory buffer and physical device.

As an example of the logging procedure, when the server stack 310 receives a “server-side” request 350 associated with a particular transaction, it processes the request and passes it through the stream sensor 312 to the service 220. Typically, each request is processed by the service in one of a pool of execution threads maintained by the server stack. In this way, different requests can be processed by the service 220 concurrently under the control of the time-sharing features of the host operating system. As the request passes through the stream sensor, if the logging rules 322 specify that the request should be logged, the stream sensor sends a log record to the log file 214.

The service 220 processes the requests 350, and in this example generates two nested “client-side” requests 351-352 that it sends to other services. The service 220 passes these through the interface 212. Each of these outbound requests is logged at the specification of the logging rules 322, in the same manner that the inbound request 350 was logged. Log records 361-362 are written to the log file based on the sensing of the outbound requests by the stream sensor 312 and the responses to the requests as they are passed back along the reverse paths as the requests. The log records are written when the responses to the outbound requests are received, and when responses to the inbound requests are sent. As an alternative, both the requests and responses can be separately logged.

The log files 214 can be accessed through the administrative interface 320, for example, to retrieve log records that satisfy particular criteria. For example, log records that span a particular time interval can be retrieved. In order to retrieve records according to other criteria, one or more index files 334 are maintained on the storage device 330. For example, a particular field of the log records, such as a “user id” field, can be designated as an index field. The index file 334 includes a data structure that enables relatively efficient access to records of the log files 214 that match particular values of an index field as compared to sequential access through the log files.

Referring to FIG. 4, a set of representative log files 214 are written by corresponding stream sensors 321. Each log file has a series of log records, each of which includes values or one or more data fields in the logged request. The logged data fields may have simple data types, such as integers or strings, or can be structured data types represented in an XML or related structured form.

A separate indexing process 410 reads the log files 214, and maintains the index file 334 (or multiple index files) corresponding to the log files. In general, one indexing process is responsible for indexing multiple log files. Optionally, multiple indexing processes 410 are used, with any one index file 334 being maintained by a single indexing process.

The multiple log files 214 can include log files generated by multiple different stream sensors or instances of stream sensors, and can include multiple sequentially generated (e.g., daily) log files generated by a single stream sensor. Note that use of a separate indexing process 410 rather than creating the index as part of the processing by the stream sensors 321 can reduce the latency introduced by the stream sensor in processing inbound and outbound service requests. Because a single index references log records that can be written by multiple stream sensors, updating of the single index, in general, requires some sort of locking mechanism so that the updating of the index by different stream sensors did not conflict. By using a single separate indexing process, updates to the index file are serialized, thereby eliminating (or at least significantly reducing) the need to lock portions of the index.

Operation of the indexing process 410 is configurable through the logging rules 322. For example, not every record of the log file is necessarily indexed, and only particular fields are selectively indexed. For the fields and records that are selected to be indexed, the index file 334 includes an efficient data structure for identifying associated records of the log files. For example, given a particular (key, value) pair, such as (“user id”, 12345), the data structure enables an efficient identification of the (file, record) pairs for associated records, where the file identifies the log file (e.g., by name) and the record identifies a particular record in the log file (e.g., by a position in the file). Various alternative index file organizations can be used, for example, based on standard B-tree or hash-based approaches.

When new log files are created periodically by a stream sensor, for example, once every hour, the oldest log files may be deleted. For example, a new log file may be started every hour, and only the last day's worth of log files retained. When a log file is deleted, the index file 334 may refer for log records that have been deleted. When the index file is used to retrieve (file, record) pairs associated with a particular key value, the existence of the referenced files is used to ignore the pairs associated with already deleted log files. The log file 334 is periodically (or repeatedly on a criterion such as file size) rebuilt, thereby avoiding the index file growing too large.

In another approach to handling the deletion of log records, the entire index is not necessarily rebuilt periodically or repeatedly but rather the data structures in the index is updated to reflect the deletion of log records, for example, on a user-specified schedule. One approach to the deletion of log records marks portions of the data structure as “stale” when log records (e.g., entire log files) are deleted. For example, the data structure may provide a way of accessing a set of identifiers of log records (a “bucket”) that may be associated with a particular range of keys. When all the identifiers in a bucket are market as stale, the updating of the index can include reclaiming the storage associated with that bucket and updating the data structure associating the keys with that bucket.

The indexing process 410 in general lags the writing of records in the log files 214. That is, there are in general log records that have been written to the logs that have not yet been indexed. In one approach to managing this lagging operation, a fixed time offset is introduced in the indexing process. For example, log records are indexed once they are one minute old (i.e., time stamped one minute in the past).

When new records are added to the index, portions (e.g., fixed length blocks) of the index file are updated. However, those portions are not necessarily immediately updated on the disk. A file of timestamps 420 indicates the latest time in each log file that is reflected in the on-disk copy of the index. In the event of a failure, such as a crash of the application server, the index is reconstructed by reading the on-disk copy of the index file and examining the log files starting at the corresponding time stamps.

Writing of updated blocks of the index file is performed in a fail-safe manner so that in the case of a failure during the updating of the on-disk copy of the log file based on the in-memory updated index, a consistent version of the index can be recreated on a failure without having to completely re-index all the log files. After a number of blocks of the index have been updated in the memory and become “dirty” blocks, as a first step to synchronizing the disk copy, the content of these blocks are written to a dirty blocks file 430. After writing one or more of the dirty blocks to the file, the indexing process suspends updating of the index and performs a synchronization of the in-memory copy of the index and the on-disk copy. To do this synchronization, the indexing process first writes a marker 432 to the end of the dirty blocks file, and then starts updating each of the dirty blocks in the index. After having updated all the dirty blocks, the indexing process updates the timestamps file 420, and then it erases the dirty blocks file or its content, and resumes the indexing process. As an alternative to writing the dirty blocks file as the first step of synchronization, the dirty blocks can be written as they are updated creating a journal of the changes that are later synchronized with the on-disk copy of the index.

The synchronization process is initiated according to the nature of the dirty blocks in the in-memory version of the index. For example, the synchronization may be initiated with a threshold number of blocks have been updated. Alternatively, the index process may include a memory manager than maintains a list of free blocks as well as a list of dirty blocks. The decision of when to initiate the synchronization may be based on one or both of the sizes of the free list and the dirty block list.

Should a failure occur after having written a dirty block to the dirty blocks file but prior to writing of the terminating marker, on restarting, the dirty blocks file is ignored and log records are reindexed starting at the timestamps. If the failure occurs after the writing of the marker, but during the updating of the on-disk copies of the dirty blocks or the timestamps, the restarting procedure performs the updating of the dirty blocks (possibly repeating the updating of a block that was already updated prior to the failure) and updates the associated timestamps.

In the approach described above, the logging rules can be updated during the operation of the system. For example, rules can be added to change which requests are logged, and rules can change which log records are indexed or change the key fields according to which they are indexed. The index 334 can include data structures for all the indexed fields. Alternatively, a separate index file can be maintained for each indexed field.

The approach described above enables replicated copies of services, for example, using separate threads or processes for a service on a single application server to logically write to a common log file without requiring the locking overhead associated with the log file truly being common. Retrieval of particular records for such a virtually common log file makes use of the common index followed by retrieval of records from typically multiple copies of the log file.

Executing the indexing process on the same application server that hosts the stream sensor generating log records and the disk storage for the log files provides efficient access to the log files. Alternatively, the indexing process and/or the index files are hosted on a different computer than the stream sensors. For example, the indexing process can access the logs through a remote file access protocol from the application server or some other computer.

In operation, the indexes support efficient access to log records that satisfy specific criteria. For example, if a monitoring application 250 needs to retrieve all log records for which the “user id” field has a particular value, the monitoring application passes that query to the administrative interface 320 at each of the application servers. The administrative servers make use of the index file 334 (or the in-memory version of the index file) to locate log records in the log files to satisfy the query.

Alternative versions of the system can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A method comprising:
monitoring records written to each of a plurality of logs; and
generating an index to records in the logs according to the monitoring of the records.

2. The method of claim 1 further comprising writing the records to each of the plurality of logs.

3. The method of claim 2 wherein the writing of records to each of the logs is performed by a corresponding task, and the monitoring and generating are performed by one or more tasks that are separate from the tasks performing the writing of the records.

4. The method of claim 3 wherein the writing of records to each of the logs is performed by a corresponding separate task for each of the logs.

5. The method of claim 4 wherein each of at least some of the corresponding separate tasks are associated with different instances of a single service.

6. The method of claim 3 wherein the tasks performing the writing and the task or tasks performing the monitoring and generating include a task from the group consisting of a process, a thread, and a program execution.

7. The method of claim 3 wherein the writing, the monitoring, and the generating are hosted on a single computer.

8. The method of claim 2 further comprising monitoring messages, and generating log records representing the monitored messages, and wherein writing the records to the logs includes writing the log records to the logs.

9. The method of claim 2 wherein writing the records to the logs comprises writing records to disk copies of the logs, and wherein monitoring the records includes monitoring the records written to the disk copies.

10. A method for indexing log files in a distributed processing system, the method comprising:
for each of a plurality of service instances, in a task associated with that service, monitoring messages communicated with the service instance and writing log records associated with the monitored messages to a log file associated with that service instance;
in one or more tasks separate from the tasks associated with the service instances, monitoring the log records written to the logs and generating an index to records in the logs according to the content of the monitored records.

11. The method of claim 10 wherein each task associated with one of the service instances is a process thread that serially processes messages for the corresponding service instance.

12. The method of claim 10 further comprising:
removing log records written to the log file; and
deferring updating of the index such that the index does not reflect the removal of the log records.

13. The method of claim 12 wherein removing the log records includes removing the entire log file.

14. The method of claim 12 wherein deferring updating of the index includes performing the updating according to a schedule.

15. The method of claim 10 wherein the index comprises data stored on a non-volatile storage and buffers stored on a volatile storage, and generating the index includes updating the buffers of the index.

16. The method of claim 15 wherein generating the index includes enabling recreating the index upon a failure during updating of the non-volatile storage of the index without requiring regenerating the entire index from the log file.

17. Software stored on computer-readable media comprising instructions for causing a computer system to:
monitor records written to each of a plurality of logs; and
generate an index to records in the logs according to the monitoring of the records.

18. The software of claim 17 wherein the instructions further cause the system to write the records to each of the plurality of logs.

19. The software of claim 18 wherein the writing of records to each of the logs is performed by a corresponding task, and the monitoring and generating are performed by one or more tasks that are separate from the tasks performing the writing of the records.

20. The software of claim 19 wherein the writing of records to each of the logs is performed by a corresponding separate task for each of the logs.

21. The software of claim 20 wherein each of at least some of the corresponding separate tasks are associated with different instances of a single service.

22. The software of claim 19 wherein the tasks performing the writing and the task or tasks performing the monitoring and generating include a task from the group consisting of a process, a thread, and a program execution.

23. The method of claim 19 wherein the writing, the monitoring, and the generating are hosted on a single computer of the computer system.

24. The software of claim 18 wherein the instructions further cause the computer system to monitor messages, and generate log records representing the monitored messages, and wherein writing the records to the logs includes writing the log records to the logs.

25. The software of claim 18 wherein writing the records to the logs comprises writing records to disk copies of the logs, and wherein monitoring the records includes monitoring the records written to the disk copies.

26. Software stored on computer-readable media comprising instructions for causing a computer system to indexing log files in a distributed processing system, the indexing comprising:
for each of a plurality of service instances, in a task associated with that service, monitoring messages communicated with the service and writing log records associated with the monitored messages to a log file associated with that service;
in one or more tasks separate from the tasks associated with the services, monitoring the log records written to the logs and generating an index to records in the logs according to the content of the monitored records.

27. A system for indexing log files comprising:
means for monitoring records written to each of a plurality of logs; and
means for generating an index to records in the logs according to the monitoring of the records.

28. A system for indexing log files comprising:
a plurality of sensor modules, each for monitoring messages, generating log records corresponding to the monitored messages, and writing the generated log records to logs; and
an indexing module for monitoring the logs and maintaining an index to the log records written to the logs.
